(19) United States
(12) Patent Application Publication
(10) Pub. No.: US 2021/0377161 A1
(43) Pub. Date: Dec. 2, 2021

(54) COMMUNICATION DEVICE, COMMUNICATION METHOD, RECORDING MEDIUM STORING COMMUNICATION PROGRAM

(71) Applicant: NEC Corporation, Minato-ku, Tokyo (JP)

(72) Inventors: Tansheng LI, Tokyo (JP); Takeo ONISHI, Tokyo (JP)

(73) Assignee: NEC Corporation, Minato-ku, Tokyo (JP)

(21) Appl. No.: 17/264,049

(22) PCT Filed: Aug. 1, 2019
(86) PCT No.: PCT/JP2019/030138

§ 371 Date: Jan. 28, 2021

(30) Foreign Application Priority Data
Aug. 6, 2018 (JP) 2018-147726

(51) Int. Cl. H04L 12/725; H04L 12/741

(52) U.S. Cl. CPC H04L 45/30; H04L 45/74

(57) ABSTRACT

A communication device is provided with: a feature information generation unit that receives a packet transmitted from a piece of equipment that performs packet communication, and consequently generates information representing a feature of the packet; a classification unit that classifies the packet into a packet group on the basis of the information representing the feature and prescribed classification criteria; an extraction unit that extracts one or more pieces of character information from the packet on the basis of prescribed extraction criteria; and an identification information generation unit that generates identification information capable of identifying the piece of equipment that transmitted the packet, such generation executed on the basis of, from among pieces of character information extracted from one or more packets belonging to the same packet group, character information in which the number of patterns pertaining to the structure of the character information satisfies a condition.

### TECHNICAL FIELD

The present invention relates to a technique of controlling communication with equipment having a simple communication function, such as an Internet of Things (IoT) device.

### BACKGROUND ART

In recent years, expectation for IoT that achieve providing various services by connecting all pieces of equipment including a simple sensor and the like to a communication network, and performing complicated system control using various pieces of data collected from these pieces of equipment has been rapidly increasing.

As one example of such a service using IoT, there is a tire management service using a vehicle-mounted IoT system. In this service, a sensor being capable of measuring a pressure and a temperature of a tire of a commercial vehicle is provided, and the sensor reports measurement data to a server on a real-time basis via a controller area network (CAN). A manager in this service is allowed to suppress a fuel cost and a cost for maintaining a tire, by analyzing data and maintaining an optimum tire pressure and the like. By applying this service, for example, it is possible to output an alert to a group of vehicles traveling around a commercial vehicle, when the server detects an anomaly such as a flat tire of the commercial vehicle.

In such IoT, a technique of configuring a system by efficiently and safely connecting various pieces of equipment (IoT devices) to a communication network is very important.

As a technique associated with such a technique, PTL 1 discloses a network device in which a terminal connectable to an internet protocol (IP) network is easily set. The device holds learning information indicating whether addresses of a plurality of terminals can be learned, address information indicating a packet to be transferred by the network device, and filter information indicating whether packet transfer is permitted. The device includes a transfer unit that transfers a packet, based on at least one of the address information and the filter information. When receiving a packet from a terminal, the transfer unit determines whether the network device can learn an address at a time of receiving the packet, based on the learning information. When it is possible to learn an address, the device stores an address of a transmission source of the received packet in the address information, and when it is not possible to learn an address, the device does not store the address of the transmission source of the received packet in the address information, and determines whether the received packet is to be transferred, based on an address included in the filter information.

PTL 2 discloses a system in which identifier allocation to an individual tire pressure monitoring device with respect to a wheel position is speedily performed after a vehicle starts traveling. The system transmits a data telegram at a first time interval, and when a pressure signal is lowered at a speed exceeding a threshold value, the system transmits the data telegram at a second time interval shorter than the first time interval, and switches the vehicle to a traveling start mode by starting a rotation sensor. The system starts a process of transmitting a data packet, after switching the vehicle to the traveling start mode. The system performs inspection after transmitting a first data packet in order to determine whether detection of wheel rotation by the rotation sensor is to be continued, and suspends the data packet transmission process. The system resumes the data packet transmission process, when the rotation sensor is re-started within a prescribed time interval. The system resumes the data packet transmission process, when the rotation sensor is re-started after the prescribed interval elapses, and switches the vehicle to a standard operation mode, after the data packet transmission is completed.

PTL 3 discloses a communication control device that appropriately controls a plurality of types of communication data. The device includes a database that stores reference data serving as a reference, based on which a method of controlling communication data is determined, pertaining to the plurality of types of communication data. The device extracts, as comparison target data, data having a predetermined length from a predetermined position of acquired communication data in such a way that search target data serving as a search target of the reference data are included, regardless of the plurality of types. The device masks data other than the search target data out of the extracted comparison target data, according to a type of the acquired communication data. The device searches for, from the database, the reference data included in the masked comparison target data, and controls the communication data according to the search result.

### CITATION LIST

### Patent Literature

[PTL 1] Japanese Patent No. 6114214

[PTL 2] Japanese Unexamined Patent Application Publication No. 2010-067267

[PTL 3] International Publication No. WO2009/075007

### SUMMARY OF INVENTION

### Technical Problem

Generally, since a large number of IoT devices in the above-described IoT are disposed not on a cloud side (on a server device side) but on an edge side (on a target side where a physical amount is measured), many of the IoT devices are inexpensive with a less number of functions. For example, there are many IoT devices in which a function of directly communicating with a communication network such as the Internet is not provided. Such an IoT device communicates with a server device via an IoT gateway such as the above-described CAN, which has a communication function with the Internet, for example.

It is often the case that an inexpensive IoT device not only does not have the above-described communication function, but also does not have a function pertaining to encryption or device authentication in communication, for example. Therefore, an IoT system constituted of the inexpensive IoT device may become a target of an impersonation attack and the like, because of being fragile against a cyber attack.

For example, in the above-described tire management service, the CAN notifies all devices in connection of data received from the IoT device. Since the CAN does not support an authentication function, specifications are configured based on a premise that an application that achieves a service introduces the authentication function by itself. Therefore, when an application provider does not provide the authentication function, a cyber attack may be easily carried out by eavesdropping data flowing through the CAN, causing illegal data imitating the eavesdropped data to flow through the CAN from a remote place via wireless communication, and the like. When the tire management service receives a cyber attack, it may not be possible to appropriately provide the service because an erroneous tire pressure is reported.

As one example of a countermeasure against such a cyber attack, there is a filtering method in which only a normal packet is used with use of a transmission source address by utilizing a firewall function. For example, PTL 1 describes a method in which an IP address and a media access control (MAC) address of a device connected to a communication network are held as a whitelist indicating device information, and the whitelist is used as filtering information. In this method, when a transmission source address of a received packet is not present in the whitelist, the packet is discarded without being transferred to a server device being a transmission destination. Specifically, the method secures security by discarding an illegal packet from a transmission source which is not registered in the whitelist, based on information by which a transmission source device can be identified.

However, in the above-described vehicle-mounted IoT system and the like, for example, there is a problem that it is difficult to extract, from a packet transmitted from an IoT gateway, identification information by which an IoT device being a transmission source can be identified, and it is difficult to distinguish a normal device from an illegal device. This is because a piece of communication equipment connected to the Internet may not recognize in which part of a packet transmitted from an IoT device identification information of the IoT device is present.

For example, when identification information is an IP address, an MAC address, or the like, it is possible to determine a storage place of information indicating an address, based on format information pertaining to a packet. However, as described above, it is often the case that an inexpensive IoT device does not have a function of directly communicating with the Internet. In this case, the IoT device transmits a packet including data to a server device via an IoT gateway. In this case, since an address pertaining to the IoT gateway is used as the IP address or the MAC address to be given to the packet, it is not possible to use the address, as identification information for identifying the IoT device itself.

Generally, a packet transmitted from an IoT device is supposed to include identification information by which the IoT device being a transmission source can be identified. However, it is often the case that specifications of a structure of a packet are not published, or the structure is not formally specified. Therefore, a piece of communication equipment connected to the Internet cannot recognize in which part of a packet transmitted from an IoT device the identification information is present. When it is not possible to recognize the identification information, it is difficult to achieve securing security as described above and the like, for example. PTLs 1 to 3 do not particularly mention this problem. A main object of the present invention is to provide a communication device and the like that solve this problem.

### Solution to Problem

A communication device according to one aspect of the present invention includes: a feature information generation means for generating, by receiving a packet transmitted from equipment that performs packet communication, information indicating a feature of the packet; a classification mans for classifying the packet into a packet group, based on information indicating the feature, and predetermined classification criteria; an extraction means for extracting one or more pieces of character information from the packet, based on predetermined extraction criteria; and an identification information generation means for generating identification information by which the equipment that transmits the packet can be identified, based on character information in which the number of patterns pertaining to a structure of the character information satisfies a condition among the character information extracted from the one or more packets belonging to the same packet group.

In another viewpoint of achieving the above-described object, a communication method according to one aspect of the present invention includes, by an information processing device: generating information indicating a feature of a packet transmitted from equipment that performs packet communication by receiving the packet; classifying the packet into a packet group, based on information indicating the feature, and predetermined classification criteria; extracting one or more pieces of character information from the packet, based on predetermined extraction criteria; and generating identification information by which the equipment that transmits the packet can be identified, based on character information in which the number of patterns pertaining to a structure of the character information satisfies a condition among the character information extracted from the one or more packets belonging to the same packet group.

In yet another viewpoint of achieving the above-described object, a communication program according to one aspect of the present invention causes a computer to execute: feature information generation processing of generating, by receiving a packet transmitted from equipment that performs packet communication, information indicating a feature of the packet; classification processing of classifying the packet into a packet group, based on information indicating the feature, and predetermined classification criteria; extraction processing of extracting one or more pieces of character information from the packet, based on predetermined extraction criteria; and identification information generation processing of generating identification information by which the equipment that transmits the packet can be identified, based on character information in which the number of patterns pertaining to a structure of the character information satisfies a condition among the character information extracted from the one or more packets belonging to the same packet group.

The present invention is also achievable by a computer-readable non-volatile recording medium storing the communication program (computer program).

### Advantageous Effects of Invention

The present invention enables extracting identification information by which equipment being a transmission source of a packet can be identified, with high accuracy, even when it is unclear in which part of the packet the identification information is present.

### BRIEF DESCRIPTION OF DRAWINGS

FIG. 1 is a block diagram illustrating a configuration of a communication system 1 according to a first example embodiment of the present invention.

FIG. 2 is a diagram exemplifying a structure of a packet management table 111 according to the first example embodiment of the present invention.

FIG. 3 is a diagram exemplifying a structure of classification criteria 120 according to the first example embodiment of the present invention.

FIG. 4 is a diagram exemplifying a structure of a packet management table 121 according to the first example embodiment of the present invention.

FIG. 5 is a diagram describing an operation of extracting character information based on extraction criteria 130 by an extraction unit 13 according to the first example embodiment of the present invention.

FIG. 6 is a diagram exemplifying a structure of a packet management table 131 according to the first example embodiment of the present invention.

FIG. 7 is a diagram describing an operation of generating identification information 140 by an identification information generation unit 14 according to the first example embodiment of the present invention.

FIG. 8 is a flowchart illustrating an operation of a communication device 10 according to the first example embodiment of the present invention.

FIG. 9 is a block diagram illustrating a configuration of a communication system 1A according to a modification example of the first example embodiment of the present invention.

FIG. 10 is diagram exemplifying a structure of transmission control information 151A according to the modification example of the first example embodiment of the present invention.

FIG. 11 is a flowchart illustrating an operation of a communication device 10A according to the modification example of the first example embodiment of the present invention.

FIG. 12 is a block diagram illustrating a configuration of a communication device 30 according to a second example embodiment of the present invention.

FIG. 13 is a block diagram illustrating a configuration of an information processing device 900 being capable of achieving a communication device according to each of the example embodiments of the present invention.

### EXAMPLE EMBODIMENT

In the following, example embodiments according to the present invention are described with reference to the drawings.

### First Example Embodiment

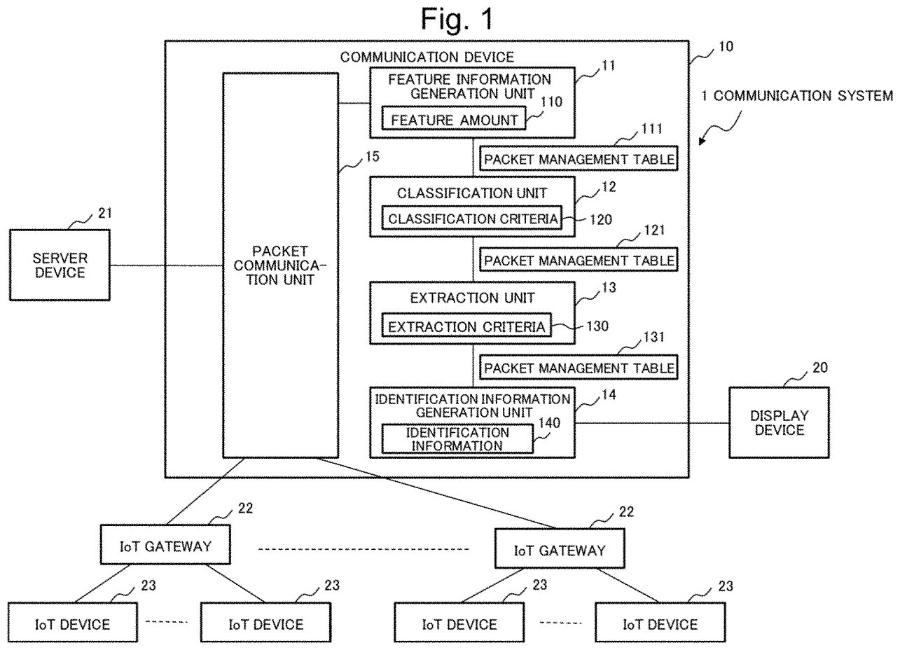

FIG. 1 is a block diagram illustrating a configuration of a communication system 1 according to a first example embodiment of the present invention. The communication system 1 roughly includes a communication device 10, a display device 20, a server device 21, one or more IoT gateways 22, and one or more IoT devices 23.

The IoT device 23 is, for example, an inexpensive sensor for measuring a physical amount (e.g. a temperature, a humidity, and the like) pertaining to a surrounding environment of a place where the sensor is installed, or a physical amount (e.g., a temperature, an acceleration in traveling, and the like) pertaining to a measurement target. Alternatively, the IoT device 23 may measure a state of an own device. It is assumed that the IoT device 23 does not have a function of directly communicating with equipment connected to a communication network such as the Internet, and is communicable with the equipment via the IoT gateway 22. Specifically, the IoT device 23 transmits, to the server device 21 via the IoT gateway 22, a packet (data) indicating a result of measuring the above-described physical amount.

The IoT device 23 communicates with the IoT gateway 22 via Bluetooth low energy (BLE (Bluetooth is a registered trademark)), for example. Alternatively, the IoT device 23 may communicate with the IoT gateway 22 via wireless communication of another standard such as ZigBee (registered trademark), or wired communication, for example.

The IoT gateway 22 communicates with the communication device 10 via a public mobile phone network such as long term evolution (LTE) (registered trademark), for example. Alternatively, the IoT gateway 22 may communicate with the communication device 10 via a wireless local area network (LAN) such as Wi-Fi (registered trademark), for example.

The server device 21 is an information processing device that provides various services by utilizing a result of measuring the above-described physical amount received from the IoT device 23. The communication device 10 is a device that relays packet communication with the server device 21 via the IoT gateway 22 by the IoT device 23. The communication device 10 may be a device that is subordinate to (mounted in) an existing relay device that relays communication with the server device 21 or communication between the server device 21 and the IoT gateway 22.

The communication device 10 according to the present example embodiment includes a feature information generation unit 11, a classification unit 12, an extraction unit 13, an identification information generation unit 14, and a packet communication unit 15.

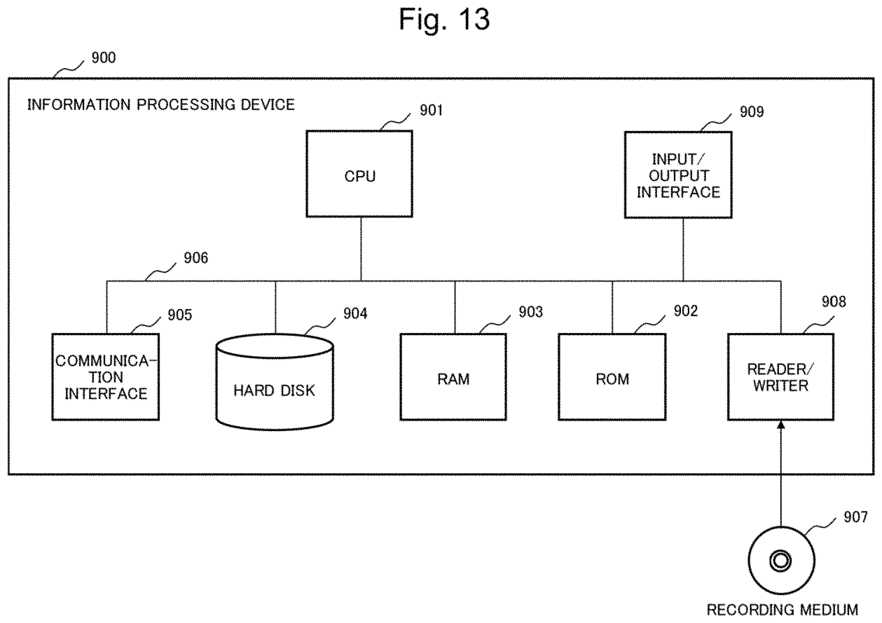

The packet communication unit 15 relays a packet to be transmitted to the server device 21 via the IoT gateway 22 by the IoT device 23. The packet communication unit 15 stores a packet received from the IoT gateway 22 in a memory such as a random access memory (RAM) 903 included in the communication device 10, which is described later with reference to FIG. 13, for example. The packet communication unit 15 gives, to the received packet, a packet number by which the packet can be uniquely identified. Pertaining to the received packet, the packet communication unit 15 notifies the feature information generation unit 11 of the given packet number and an address in the memory storing the packet, in association with each other.

The feature information generation unit 11 calculates (generates) a feature amount 110 (feature information) of a packet, based on a situation when the packet communication unit 15 receives the packet, a mode of the received packet, and the like. For example, the feature amount 110 is a size of a packet received by the packet communication unit 15. The feature information generation unit 11 can calculate a size of a packet, based on a memory capacity occupied by the packet stored in a memory, header information pertaining to a communication protocol such as a transmission control protocol (TCP), and the like.

Alternatively, the feature information generation unit 11 may calculate the feature amount 110 pertaining only to a specific packet having a specific network attribute. The network attribute represents prescribed information such as an IP address, a port number, or a communication protocol, which is necessary for equipment connected to a communication network to transmit and receive a packet. The feature information generation unit 11 may calculate the feature amount 110 pertaining only to a specific packet transmitted by using a user datagram protocol (UDP), or calculate the feature amount 110 pertaining only to a specific packet for establishing a TCP session.

The feature information generation unit 11 may calculate, as the feature amount 110, a difference between a time when the packet is received and a time when a packet preceding the packet is received, or a connection time (connection period) of a (TCP) session to which the packet belongs, or the number of packets belonging to the session, or a transmission interval of the packet, or a reception time of the packet, or the like. Alternatively, the feature information generation unit 11 may set, as the feature amount 110 pertaining to a plurality of packets, a result of performing statistical calculation (such as an average value or a distribution) with respect to the feature amount 110 pertaining to the plurality of packets. The feature information generation unit 11 generates a packet management table 111 indicating the calculated feature amount 110, and stores the generated packet management table 111 in a memory such as the RAM 903.

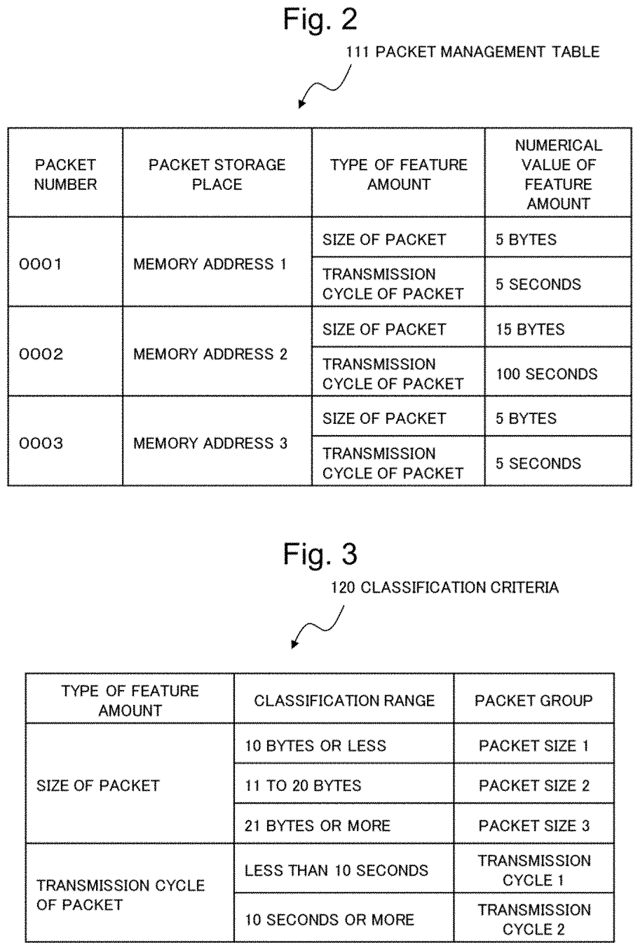

FIG. 2 is a diagram exemplifying a structure of the packet management table 111 according to the present example embodiment. As exemplified in FIG. 2, the packet management table 111 is information in which at least a packet number given by the packet communication unit 15, a memory address storing a packet, a type of the feature amount 110, and a numerical value of the feature amount 110 are associated with one another.

According to the packet management table 111 exemplified in FIG. 2, for example, a packet having a packet number 0001 (in the present description, hereinafter, the packet is referred to as a packet 0001, and the same definition is applied to packets having other packet numbers) is stored in a memory address 1, a size of the packet 0001 is 5 bytes, and a transmission cycle of the packet 0001 is 5 seconds. According to the packet management table 111 exemplified in FIG. 2, a packet 0002 is stored in a memory address 2, a size of the packet 0002 is 15 bytes, and a transmission cycle of the packet 0002 is 100 seconds. The feature information generation unit 11 notifies the classification unit 12 illustrated in FIG. 1 of the generated packet management table 111.

The classification unit 12 classifies a packet received by the packet communication unit 15 into a packet group (group), based on the feature amount 110 indicated by the packet management table 111 generated by the feature information generation unit 11, and predetermined classification criteria 120. It is assumed that the classification criteria 120 are stored in advance in a memory such as the RAM 903, for example, by a manager or the like of the communication device 10, for example. It is assumed that the packet group is, for example, a set of packets in which the feature amount 110 is the same or similar (specifically, classified based on a degree of similarity pertaining to the feature amount 110). It is assumed that the classification unit 12 according to the present example embodiment allocates, to an individual packet group, a uniquely identifiable identifier (e.g. a combination of a name indicating a type of a feature amount, and a serial number).

FIG. 3 is a diagram exemplifying a structure of the classification criteria 120 according to the present example embodiment. According to the classification criteria 120 exemplified in FIG. 3, a packet having a size of 10 bytes or less is classified into a packet group called “packet size 1”, a packet having a size from 11 to 20 bytes is classified into a packet group called “packet size 2”, and a packet having a size of 21 bytes or more is classified into a packet group called “packet size 3”. According to the classification criteria 120 exemplified in FIG. 3, a packet having a transmission cycle of less than 10 seconds is classified into a packet group called “transmission cycle 1”, and a packet having a transmission cycle of 10 seconds or more is classified into a packet group called “transmission cycle 2”.

The classification unit 12 generates a packet management table 121 by incorporating, in the packet management table 111 generated by the feature information generation unit 11, a result acquired by classifying a packet received by the packet communication unit 15 into a packet group, based on the classification criteria 120.

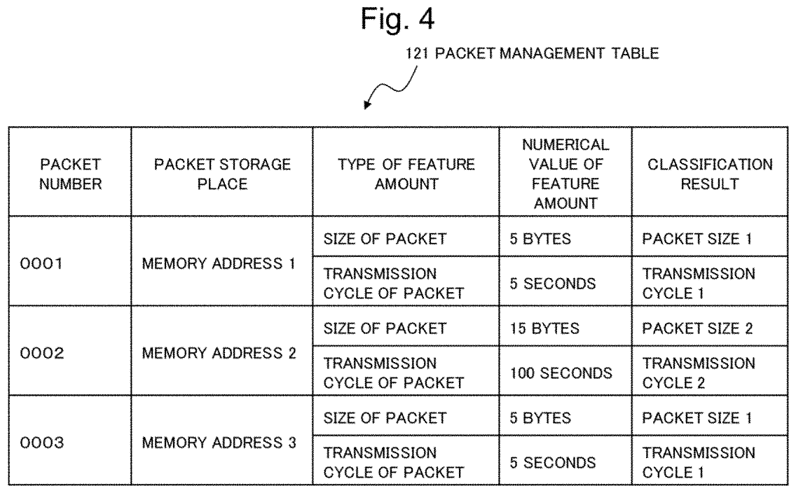

FIG. 4 is a diagram exemplifying a structure of the packet management table 121 according to the present example embodiment. According to the packet management table 121 exemplified in FIG. 4, the classification unit 12 classifies the packet 0001 into the packet group called “packet size 1”, pertaining to a size of a packet, and classifies the packet 0001 into the packet group called “transmission cycle 1”, pertaining to a transmission cycle of a packet. According to the packet management table 121 exemplified in FIG. 4, the classification unit 12 classifies the packet 0002 into the packet group called “packet size 2”, pertaining to a size of a packet, and classifies the packet 0002 into the packet group called “transmission cycle 2”, pertaining to a transmission cycle of a packet. The classification unit 12 notifies the extraction unit 13 illustrated in FIG. 13 of the generated packet management table 121.

The extraction unit 13 extracts one or more character strings (character information) from each packet, based on the packet management table 121 generated by the classification unit 12, and predetermined extraction criteria 130. The character string is a string constituted of characters to be specified by a character code. It is assumed that the extraction criteria 130 are stored in advance in a memory such as the RAM 903, for example, by an administrator or the like of the communication device 10, for example.

The extraction unit 13 extracts a character string (character information) included in a packet by performing the following two pieces of processing in order, for example. Specifically, the extraction unit 13 determines, as a first piece of processing, a communication protocol pertaining to transmission and reception of a packet, based on a port number pertaining to the packet. Then, the extraction unit 13 extracts, as a second piece of processing, a character string from a specific range in a header or a payload of the packet according to the determined communication protocol.

Pertaining to the above-described first piece of processing, the extraction unit 13 determines a communication protocol, in accordance with regulations defined by the Internet Assigned Numbers Authority (IANA) being an organization that manages port numbers. Specifically, for example, when the port number pertaining to a packet is “80”, the extraction unit 13 determines that a communication protocol of an application layer in an Open Systems Interconnection (OSI) reference model is hyper text transfer protocol (HTTP), and when the port number is “1883”, the extraction unit 13 determines that the communication protocol is message queueing telemetry transport (MQQT).

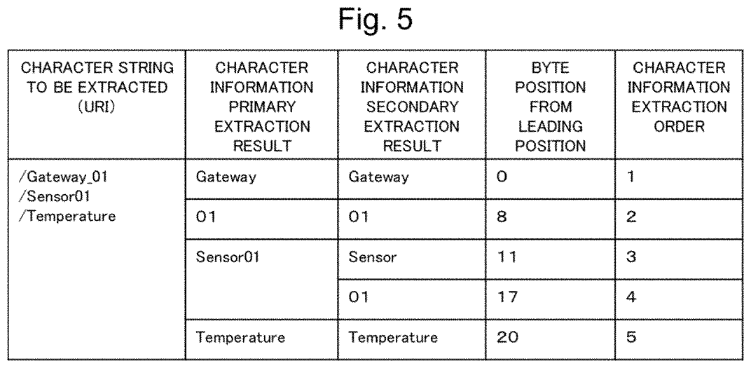

Next, the above-described second piece of processing based on the extraction criteria 130, by the extraction unit 13 is described with reference to FIG. 5. In the example illustrated in FIG. 5, the extraction unit 13 determines that the communication protocol is HTTP by the above-described first piece of processing, and sets a uniform resource identifier (URI) of the HTTP included in the packet, as a target from which a character string (character information) is extracted. When the extraction unit 13 determines that the communication protocol is MQQT by the above-described first piece of processing, the extraction unit 13 sets a payload of the MQQT as a target from which a character string is extracted.

In the example illustrated in FIG. 5, the URI from which a character string is extracted is “/Gateway_01/Sensor01/Temperature”. In FIG. 1, “Gateway_01” is an identifier by which the IoT gateway 22 that has transmitted a packet to the communication device 10 can be identified. “ Sensor01” is an identifier by which the IoT device 23 being a transmission source of the packet can be identified. “Temperature” is a character string indicating that the packet is a packet indicating temperature information.

First, the extraction unit 13 recognizes “/” and “_” included in the URI, as a character indicating a boundary at the time of dividing and extracting a character string, based on the extraction criteria 130. Thus, as illustrated as a character information primary extraction result in FIG. 5, the extraction unit 13 extracts four character strings “Gateway”, “01”, “Sensor01”, and “Temperature”, from “/Gateway_01/Sens or01/Temperature”.

Next, the extraction unit 13 further divides the character strings at a position where a type of a character changes. The type of a character is, for example, an alphabet, a number, a symbol, a Chinese character, and the like. In the example illustrated in FIG. 5, the extraction unit 13 further divides “Sensor01” and extracts “Sensor” and “01” out of the character strings extracted as the character information primary extraction result. In this way, as illustrated as a character information secondary extraction result in FIG. 5, the extraction unit 13 extracts five character strings “Gateway”, “01”, “Sensor”, “01”, and “Temperature”, from “/Gateway_01/Sensor01/Temperature”.

The extraction unit 13 further calculates an order in which character strings are extracted. For example, as exemplified in FIG. 5, the extraction unit determines an order in which character strings are extracted in an increasing order of a byte position value by comparing byte positions from a leading position of a URI, pertaining to the extracted character strings.

The extraction unit 13 generates a packet management table 131 by incorporating, in the packet management table 121 generated by the classification unit 12, a result acquired by extracting, from a packet received by the packet communication unit 15, character strings (character information), based on the extraction criteria 130 as described above.

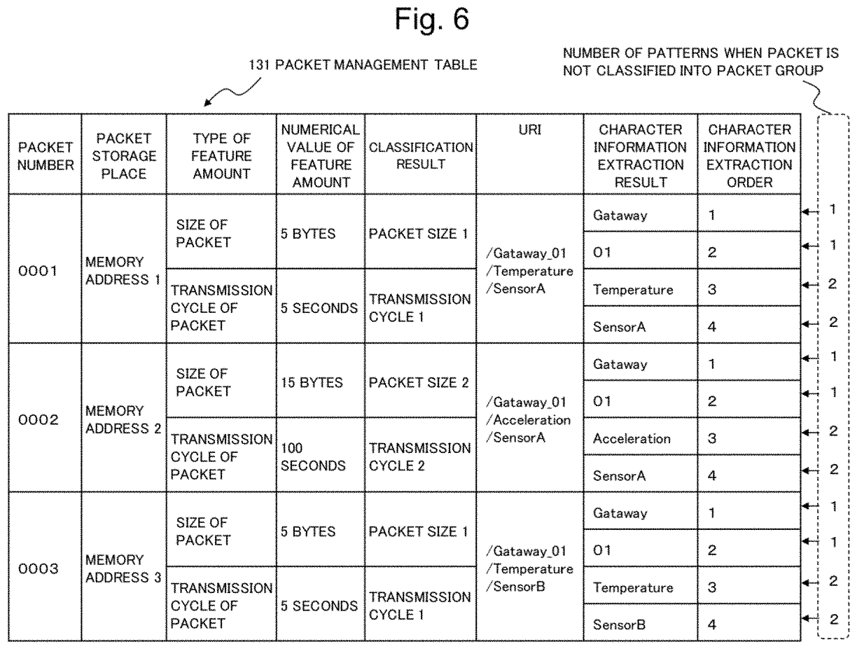

FIG. 6 is a diagram exemplifying a structure of the packet management table 131 according to the present example embodiment. In the packet management table 131 exemplified in FIG. 6, URIs from which 2the extraction unit 13 extracts character strings, pertaining to the packet 0001, the packet 0002, and the packet 0003, are in this order “/Gateway_01/Temperature/SensorA”, “Gateway_01/Acceleration/SensorA”, and “Gateway_01/Temperature/SensorB”. Note that, in the packet 0002, “Acceleration” is a character string indicating that the packet is a packet indicating acceleration information. The extraction unit 13 notifies the identification information generation unit 14 illustrated in FIG. 1 of the generated packet management table 131.

The identification information generation unit 14 specifies a character string in which the number of patterns (number of types) pertaining to a structure of a character string satisfies a certain condition among character strings (character information) extracted from each packet belonging to a same packet group, based on the packet management table 131 generated by the extraction unit 13. For example, when both of character strings respectively extracted from two packets are a same character string “ABC”, the number of patterns becomes “1”; and when character strings respectively extracted from the two packets are different character strings “ABC” and “ABD”, the number of patterns becomes “2”. Then, the identification information generation unit 14 generates identification information 140 by which the IoT device 23 that has transmitted a packet can be identified, based on the specified character string. The identification information generation unit 14 according to the present example embodiment sets that having the largest number of patterns is the certain condition, for example. Specifically, the identification information generation unit 14 specifies a character string in which the number of unique character strings (character strings distinguishable from one another) is the largest among a plurality of extracted character strings.

In the packet management table 131 exemplified in FIG. 6, both of the packet 0001 and the packet 0003 belong to the packet group “packet size 1”, pertaining to a size of a packet, and belong to the packet group “transmission cycle 1”, pertaining to a transmission cycle of a packet. Therefore, the identification information generation unit 14 specifies the packet 0001 and the packet 0003 as packets belonging to a same packet group, pertaining to a combination of two packet groups.

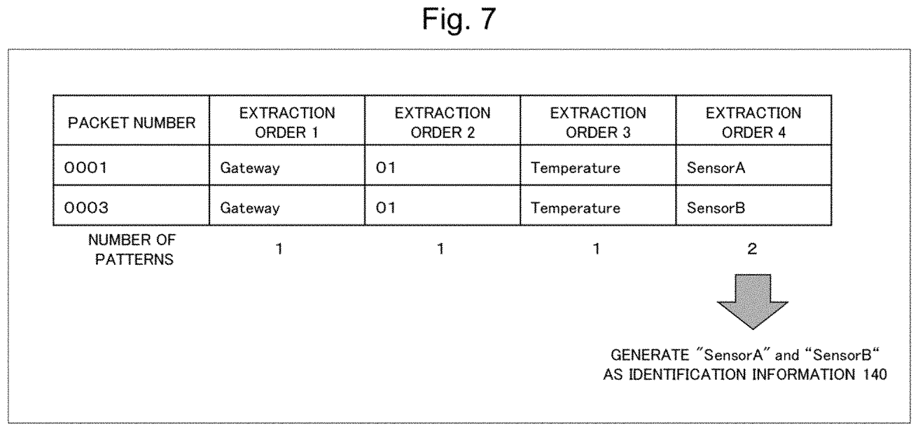

FIG. 7 is a diagram describing an operation of generating the identification information 140 by the identification information generation unit 14, pertaining to each packet belonging to a same packet group. The identification information generation unit 14 calculates the number of patterns pertaining to a character string, with respect to character strings having the same extraction order.

In FIG. 7, a character string having an extraction order “1” is a same character string “Gateway” in both of the packet 0001 and the packet 0003. Therefore, the identification information generation unit 14 calculates the number of patterns pertaining to a character string having the extraction order “1” as “1”. This indicates that it is not possible to uniquely identify the IoT device 23 being a transmission source of the packet 0001 and the IoT device 23 being a transmission source of the packet 0003 by the extracted character string “Gateway”.

In FIG. 7, a character string having an extraction order “2” is a same character string “01” in both of the packet 0001 and the packet 0003, and a character string having an extraction order “3” is a same character string “Temperature” in both of the packet 0001 and the packet 0003. Therefore, similarly, the identification information generation unit 14 calculates the number of patterns pertaining to the character string having the extraction order “2” and the character string having the extraction order “3” as “1”.

In FIG. 7, a character string having an extraction order “4” is “SensorA” pertaining to the packet 0001, and “SensorB” pertaining to the packet 0003, thus these two character strings are different from each other. Therefore, the identification information generation unit 14 calculates the number of patterns pertaining to the character string having the extraction order “4” as “2”.

Thus, in the example illustrated in FIG. 7, the identification information generation unit 14 specifies the character string having the extraction order “4”, as a character string having the largest number of patterns. The identification information generation unit 14 generates, as the identification information 140 by which the IoT device 23 that has transmitted the packet 0001 can be identified, “SensorA” extracted as a character string having the extraction order “4” from the packet 0001. The identification information generation unit 14 generates, as the identification information 140 by which the IoT device 23 that has transmitted the packet 0003, “SensorB” extracted as a character string having the extraction order “4” from the packet 0003.

According to the packet management table 131 exemplified in FIG. 6, there is no other packet belonging to a packet group to which the packet 0002 belongs. In such a case, the identification information generation unit 14 generates the identification information 140 by which the IoT device 23 that has transmitted the packet 0002 can be identified, in such a way as to be consistent with pieces of the identification information 140 pertaining to the packet 0001 and the packet 0003. Specifically, the identification information generation unit 14 generates, as the identification information 140 by which the IoT device 23 that has transmitted the packet 0002 can be identified, “SensorA” extracted as a character string having the extraction order “4” from the packet 0002.

The identification information generation unit 14 displays, on the display device 20 illustrated in FIG. 1, a packet and the identification information 140 pertaining to the packet, in association with each other. The display device 20 is, for example, a device such as a monitor. When the packet management table 131 indicates a content exemplified in FIG. 6, for example, the identification information generation unit 14 displays, on the display device 20, that pieces of the identification information 140 pertaining to the IoT devices 23 being transmission sources of the packet 0001, the packet 0002, and the packet 0003 are in this order “SensorA”, “SensorA”, and “SensorB”. The identification information generation unit 14 may additionally display, on the display device 20, an identifier of the IoT gateway 22 that has transmitted each packet, a URI included in each packet, and the like.

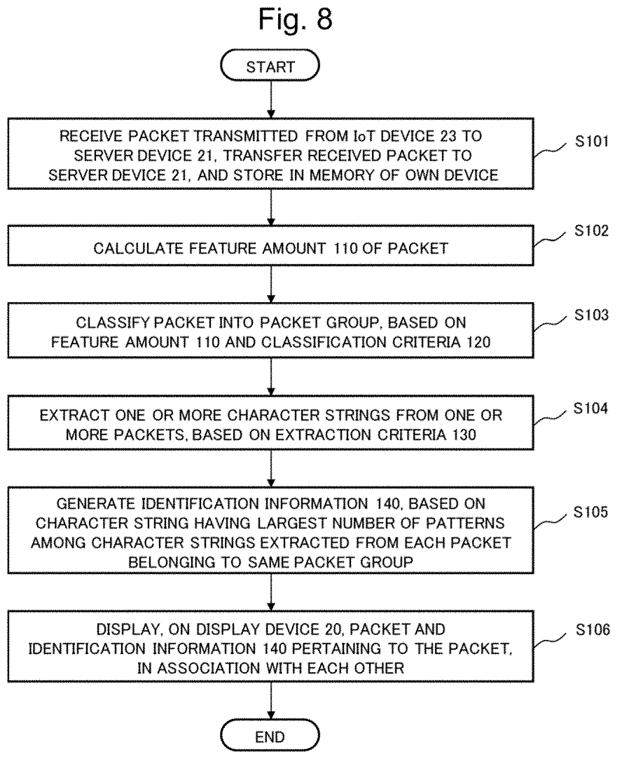

Next, an operation (processing) of the communication device 10 according to the present example embodiment is described in detail with reference to a flowchart in FIG. 8.

The packet communication unit 15 receives a packet transmitted from the IoT device 23 to the server device 21, transfers the received packet to the server device 21, and stores the received packet in a memory of an own device (Step S101). The feature information generation unit 11 calculates the feature amount 110 of the packet, based on a situation when the packet communication unit 15 receives the packet, a mode of the received packet, and the like, and generates the packet management table 111 indicating a result of the calculation (Step S102).

The classification unit 12 classifies the packet into a packet group, based on the packet management table 111 and the classification criteria 120, and generates the packet management table 121 by incorporating a result of the classification in the packet management table 111 (Step S103). The extraction unit 13 extracts one or more character strings from one or more packets, based on the packet management table 121 and the extraction criteria 130, and generates the packet management table 131 by incorporating a result of the extraction in the packet management table 121 (Step S104).

The identification information generation unit 14 specifies a character string having the largest number of patterns, among character strings indicated in the packet management table 131 and extracted from each packet belonging to a same packet group; and generates the identification information 140 by which the IoT device 23 that has transmitted the packet can be identified, based on the specified character string (Step S105). The identification information generation unit 14 displays, on the display device 20, the packet and the identification information pertaining to the packet, in association with each other (Step S106), and the entire processing is finished.

Even when it is unclear in which part of a packet, identification information by which equipment being a transmission source of the packet can be identified is present, the communication device 10 according to the present example embodiment is capable of extracting the identification information with high accuracy. A reason for this is that the communication device 10 generates information indicating a feature of a packet, classifies the packet into a packet group, based on information indicating the feature, and generates identification information by which equipment being a transmission source of the packet can be identified, based on character information in which the number of patterns pertaining to a structure of the character information satisfies a condition among the character information extracted from a packet belonging to a same packet group.

In the following, an advantageous effect to be achieved by the communication device 10 according to the present example embodiment is described in detail.

Generally, since a large number of IoT devices in an IoT system are disposed on an edge side, many of the devices are inexpensive with a less number of functions. For example, there are many IoT devices in which a function of directly communicating with a communication network such as the Internet is not provided. In such an IoT system, since an IP address or an MAC address given to a packet to be transmitted to a server device via an IoT gateway uses an address pertaining to the IoT gateway, it is not possible to use the address as identification information for identifying the IoT device itself. Generally, a packet transmitted from an IoT device is supposed to include identification information by which the IoT device being a transmission source can be identified. However, it is often the case that specifications of a structure of a packet are not published, or the structure is not formally specified. Therefore, a piece of communication equipment connected to the Internet cannot recognize in which part of a packet transmitted from an IoT device, the identification information is present. There is a problem that it is difficult to secure, for example, security of an IoT system and the like, when it is not possible to recognize the identification information.

In view of the above-described problem, the communication device 10 according to the present example embodiment includes the feature information generation unit 11, the classification unit 12, the extraction unit 13, and the identification information generation unit 14, and is operated as described above with reference to FIGS. 1 to 8. Specifically, the feature information generation unit 11 generates (calculates), by receiving the packet transmitted from the IoT device 23 that performs packet communication, information (feature amount 110) indicating a feature of a packet. The classification unit 12 classifies the packet into a packet group, based on information indicating the feature and the predetermined classification criteria 120. The extraction unit 13 extracts one or more pieces of character information from the packet, based on the predetermined extraction criteria 130. Then, the identification information generation unit 14 generates the identification information 140 by which the IoT device 23 that has transmitted the packet can be identified, based on character information in which the number of patterns pertaining to a structure of the character information satisfies a condition among the character information extracted from one or more packets belonging to a same packet group.

Herein, an advantageous effect by comparing the number of patterns pertaining to a character string extracted from a packet belonging to a same packet group is described in more detail with reference to FIG. 6.

As exemplified in FIG. 6, it is often the case that a URI included in a packet transmitted from the IoT device 23 includes information indicating a type of a collected physical amount. For example, URIs indicated by the packet 0001 and the packet 0003 including temperature information include a character string “Temperature”, in addition to “SensorA” or “SensorB” by which the IoT device 23 can be identified. A URI indicated by the packet 0002 including acceleration information includes a character string “Acceleration”, in addition to “SensorA” by which the IoT device 23 can be identified.

In FIG. 6, the number of patterns described on the right side of the packet management table 131 indicates the number of patterns pertaining to a character string extracted from each packet, when a packet is not classified into a packet group, based on the feature amount 110. For example, pertaining to a character string having the character information extraction order “1”, a sole character string extracted from the packets 0001 to 0003 is “Gateway”, and the number of patterns is “1”. Pertaining to a character string having the character information extraction order “2”, a sole character string extracted from the packets 0001 to 0003 is “01”, and the number of patterns is “1”. Pertaining to a character string having the character information extraction order “3”, character strings extracted from the packets 0001 to 0003 are “Temperature” or “Acceleration”, and the number of patterns is “2”. Pertaining to a character string having the character information extraction order “4”, character strings extracted from the packets 0001 to 0003 are “SensorA” or “SensorB”, and the number of patterns is “2”.

Therefore, when the identification information 140 is generated based on a character string having the smallest character information extraction order (earliest order) among character strings in which the number of patterns satisfies a condition (being largest), the identification information 140 is not generated based on “SensorA” or “SensorB”, which is originally expected as the identification information 140, but is generated based on “Temperature” or “Acceleration”, and accuracy as the identification information 140 is lowered.

Generally, a correlation between a type of information to be collected (sensed) by the IoT device 23 and the feature amount 110 of a packet is high. For example, pertaining to two of the IoT devices 23 that collect a same physical amount (e.g. temperature information), a feature (such as a packet size or a transmission cycle) of packets transmitted from the IoT devices 23 are similar to each other. On the other hand, pertaining to two of the IoT devices 23 that collect different physical amounts (e.g. temperature information and acceleration information), a feature of packets transmitted from the IoT devices 23 are greatly different from each other. The communication device 10 classifies in such a way that packets transmitted from functionally similar ones of the IoT devices 23 belong to a same packet group, by utilizing the correlation between a type of information to be collected by the IoT device 23 and the feature amount 110 of a packet.

The communication device 10 according to the present example embodiment avoids, at the time of comparing the number of patterns of a character string extracted from a packet, generating the identification information 140, based on a character string (e.g. a character string indicating a type of a collected physical amount, or the like) other than a specific character string that is originally expected as the identification information 140, as described in the above-described example, by narrowing down packets for comparison to packets belonging to a same packet group (specifically, having a similar feature). Thus, the communication device 10 according to the present example embodiment is capable of extracting identification information with high accuracy, even when it is unclear in which part of a packet, the identification information by which equipment being a transmission source of the packet can be identified is present.

A condition at the time of generating the identification information 140 by the identification information generation unit 14 according to the present example embodiment is not limited to a condition that the identification information is based on a character string having the largest number of patterns among character strings extracted from a packet. For example, when it is not required to individually identify a plurality of certain IoT devices 23 (high resolution pertaining to identification is not required), or the like, the identification information generation unit 14 may employ, as the condition, a condition that the number of patterns is a threshold value or more, and the like.

The extraction criteria 130 according to the present example embodiment indicate extracting, as character information, a character string indicating a header or a payload of a protocol in an application layer included in a packet. Specifically, since the communication device 10 according to the present example embodiment uses, as the extraction criteria 130, existing specifications pertaining to a packet transmitted from the IoT device 23, it is possible to suppress a cost necessary for mounting the communication device 10 in an existing system.

Since the extraction criteria 130 according to the present example embodiment are simple criteria that a character string divided by a specific character or a character string divided by a change in a type of a character is extracted, an administrator of the communication device 10 can easily generate the extraction criteria 130.

The identification information generation unit 14 according to the present example embodiment generates the identification information 140 pertaining to each of a plurality of packets, based on a character string located at a position where the order from a character string located at a leading position is the same among character strings extracted from each of the plurality of packets. Thus, the communication device 10 according to the present example embodiment is capable of generating the identification information 140 in such a way that pieces of the identification information 140 are consistent with one another among a plurality of the IoT devices 23.

The identification information generation unit 14 according to the present example embodiment displays, on the display device 20, a packet and the identification information 140 pertaining to the packet, in association with each other. Thus, the communication device 10 according to the present example embodiment allows an administrator of the communication device 10 to easily confirm the identification information 140.

### Modification Example of First Example Embodiment

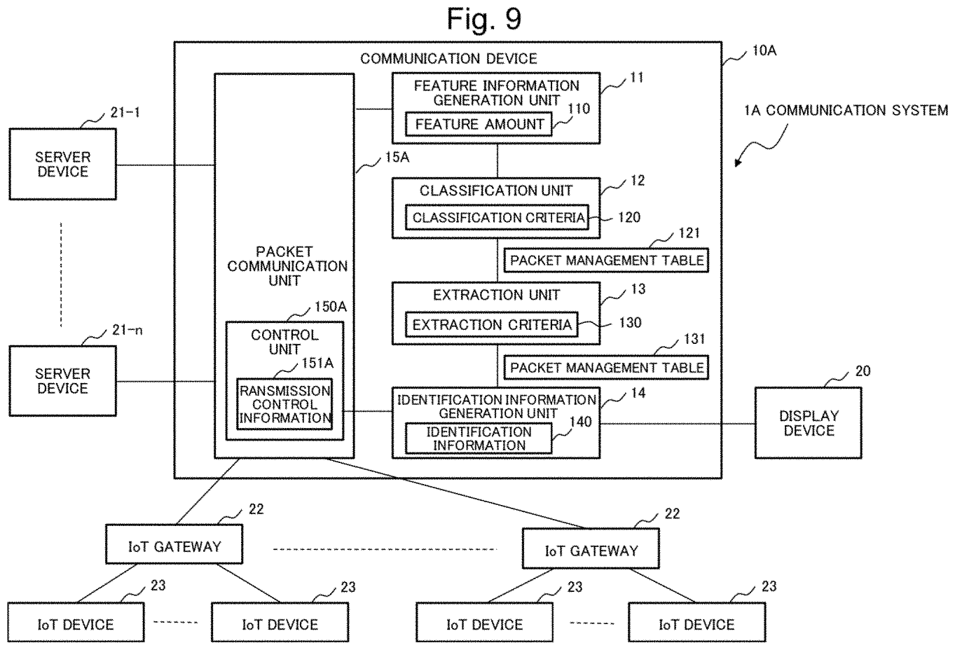

FIG. 9 is a block diagram illustrating a configuration of a communication system 1A according to a modification example of the first example embodiment of the present invention. The communication system 1A roughly includes a communication device 10A, a display device 20, server devices 21-1 to 21-n (where n is any integer), one or more IoT gateways 22, and one or more IoT devices 23. Out of components included in the communication system 1A according to the present modification example, detailed description on the components having functions equivalent to those in the above-described first example embodiment is omitted by giving the same reference signs as those in the first example embodiment.

The communication device 10A according to the present modification example includes a feature information generation unit 11, a classification unit 12, an extraction unit 13, an identification information generation unit 14, and a packet communication unit 15A. Specifically, the communication device 10A according to the present modification example is different from the communication device 10 according to the above-described first example embodiment in a function of the packet communication unit 15A.

The packet communication unit 15A includes a control unit 150A. The control unit 150A temporarily suspends transfer of a received packet to the server device 21-i (where i is any integer from 1 to n) being a transmission destination, and stores the packet in a memory of an own device. The control unit 150A controls transmission of the packet stored in the memory of the own device, based on identification information 140 pertaining to the packet received from the IoT device 23 via the IoT gateway 22, and transmission control information 151A.

It is assumed that the transmission control information 151A according to the present example embodiment is a whitelist indicating whether the IoT device 23 being a transmission source of a packet to be identified by the identification information 140 is a safe device that is confirmed in advance. It is assumed that the transmission control information 151A indicates a route (server device 21-i being a transmission destination) and the like along which a packet is transmitted from the communication device 10A, pertaining to the packet in which the identification information 140 is registered. It is also assumed that the transmission control information 151A indicates that discarding a packet, and the like, pertaining to the packet in which the identification information 140 is not registered.

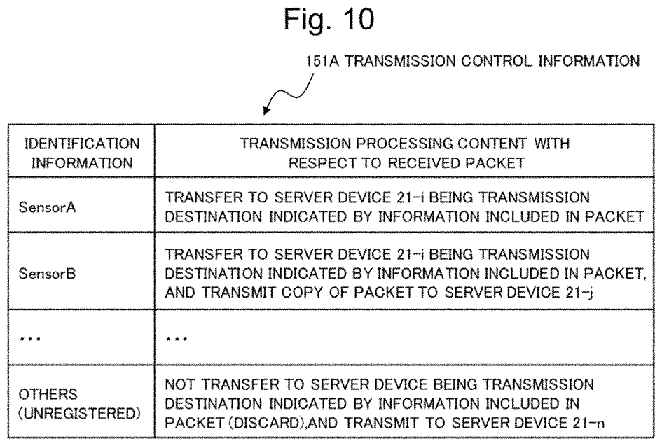

FIG. 10 is a diagram exemplifying a structure of the transmission control information 151A according to the present example embodiment. According to the transmission control information 151A exemplified in FIG. 10, the control unit 150A transfers, to the server device 21-i being a transmission destination indicated by information included in a packet, the packet transmitted from the IoT device 23 to be identified by indication of “SensorA” by the identification information 140. According to the transmission control information 151A exemplified in FIG. 10, the control unit 150A transfers, to the server device 21-i being a transmission destination indicated by information included in a packet, the packet transmitted from the IoT device 23 to be identified by indication of “SensorB” by the identification information 140 and transmits a copy of the packet to the server device 21-j (where j is an integer from 1 to n, and being different from i). However, the server device 21-j is, for example, a standby system server device in the communication system 1A including an operational system server device and the standby system server device.

According to the transmission control information 151A exemplified in FIG. 10, the control unit 150A does not transfer, to a server device being a transmission destination indicated by information included in a packet, the packet transmitted from the IoT device 23 in which the identification information 140 is not registered in the transmission control information 151A (discards a packet), and transmits the packet to the server device 21-n . The server device 21-n is a quarantine server device that analyzes whether a packet is illegal, for example.

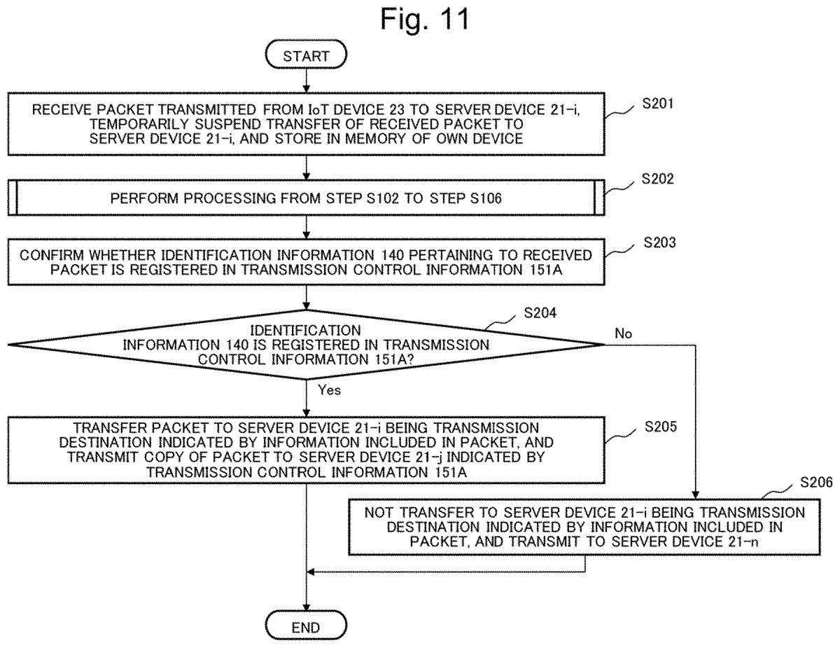

Next, an operation (processing) of the communication device 10A according to the present modification example is described in detail with reference to a flowchart in FIG. 11.

The packet communication unit 15A receives a packet transmitted from the IoT device 23 to the server device 21-i , temporarily suspends transfer of the received packet to the server device 21, and stores the packet in a memory of an own device (Step S201). The communication device 10A performs processing from Step S102 to Step S106 illustrated in FIG. 8 (Step S202).

The control unit 150A in the packet communication unit 15A confirms whether the identification information 140 pertaining to the received packet is registered in the transmission control information 151A (Step S203).

When the identification information 140 is registered in the transmission control information 151A (Yes in Step S204), the control unit 150A transfers, to the server device 21-i being a transmission destination indicated by information included in the packet, the packet stored in the memory of the own device, and transmits a copy of the packet to the server device 21-j indicated by the transmission control information 151A (Step S205), and the entire processing is finished.

When the identification information 140 is not registered in the transmission control information 151A (No in Step S204), the control unit 150A does not transfer, to the server device 21-i being the transmission destination indicated by the information included in the packet, and transmits the packet to the server device 21-n (Step S205), and the entire processing is finished.

Even when it is unclear in which part of a packet, identification information by which equipment being a transmission source of the packet can be identified is present, the communication device 10A according to the present example embodiment is capable of extracting the identification information with high accuracy. A reason for this is as described in the first example embodiment.

The control unit 150A according to the present modification example performs, based on the transmission control information 151A indicating a content of transmission processing for a packet transmitted from the IoT device 23 to be identified by the identification information 140, at least either one of selecting a route along which the packet is transmitted or discarding the transmitted packet. Specifically, since the communication device 10A according to the present modification example is capable of controlling packet transfer, based on a whitelist pertaining to the identification information 140, it is possible to improve security level of an IoT system.

### Second Example Embodiment

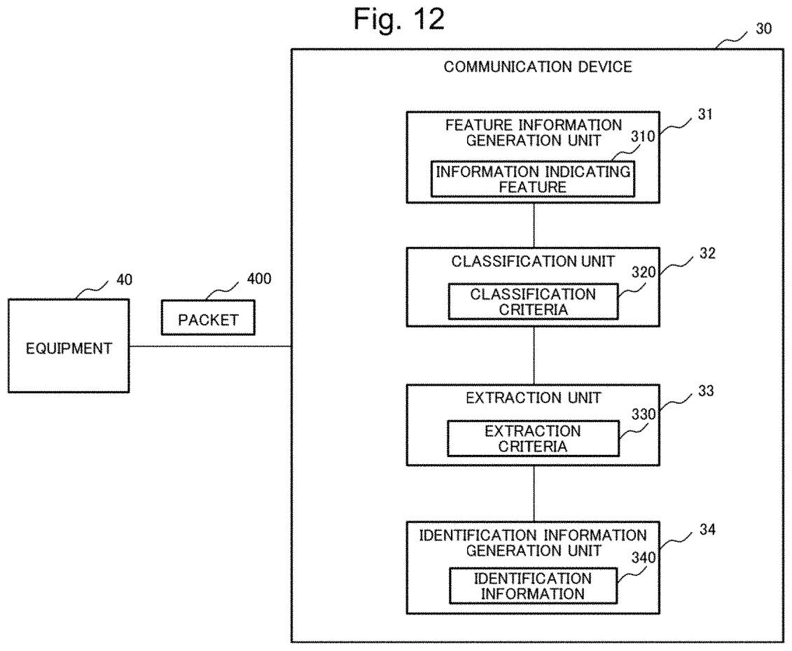

FIG. 12 is a block diagram illustrating a configuration of a communication device 30 according to a second example embodiment of the present invention.

The communication device 30 according to the present example embodiment includes a feature information generation unit 31, a classification unit 32, an extraction unit 33, and an identification information generation unit 34.

The feature information generation unit 31 generates, by receiving a packet 400 transmitted from equipment 40 that performs packet communication, information 310 indicating a feature of the packet 400.

The classification unit 32 classifies the packet 400 into a packet group, based on the information 310 indicating a feature, and predetermined classification criteria 320.

The extraction unit 33 extracts one or more pieces of character information from the packet 400, based on predetermined extraction criteria 330.

The identification information generation unit 34 generates identification information 340 by which the equipment 40 that has transmitted the packet 400 can be identified, based on character information in which the number of cases where the character information of packets are different from each other satisfies a condition among character information extracted from one or more packets 400 belonging to a same packet group.

Even when it is unclear in which part of a packet, identification information by which equipment being a transmission source of the packet can be identified is present, the communication device 30 according to the present example embodiment is capable of extracting the identification information with high accuracy. A reason for this is that the communication device 30 generates the information 310 indicating a feature of the packet 400, classifies the packet 400 into a packet group, based on the information 310 indicating the feature, and generates the identification information 340 by which the equipment 40 being a transmission source of the packet can be identified, based on character information in which the number of patterns pertaining to a structure of the character information satisfies a condition among the character information extracted from the packet 400 belonging to a same packet group.

<Hardware Configuration Example>

In the above-described example embodiments, each unit in the communication devices illustrated in FIGS. 1, 9, and 12 is achievable by a dedicated hardware (HW) (electronic circuit). In FIGS. 1, 9, and 12, at least the following components can be regarded as function (processing) units (software modules) of a software program.

The feature information generation units 11 and 31,

the classification units 12 and 32,

the extraction units 13 and 33,

the identification information generation units 14 and 34, and

the control unit 150A.

However, classification of the units illustrated in these drawings is a configuration for convenience of explanation, and when the units are actually mounted, various configurations can be proposed. One example of a hardware environment in this case is described with reference to FIG. 13.

FIG. 13 is a diagram exemplarily illustrating a configuration of an information processing device 900 (computer) being capable of achieving a relocation management device according to the example embodiments of the present invention. Specifically, FIG. 13 illustrates a configuration of a computer (information processing device) being capable of achieving the communication devices illustrated in FIGS. 1, 9 and 12, and illustrates a hardware environment in which the functions in the above-described example embodiments can be achieved.

The information processing device 900 illustrated in FIG. 13 includes the following, as constituent elements.

A central processing unit (CPU) 901,

a read only memory (ROM) 902,

a random access memory (RAM) 903,

a hard disk (storage device) 904,

a communication interface 905,

a bus 906 (communication line),

a reader/writer 908 being capable of reading and writing data stored in a recording medium 907 such as a compact disc read only memory (CD-ROM), and

an input/output interface 909 such as a monitor, a speaker, and a keyboard.

Specifically, the information processing device 900 including the above-described constituent elements is a general computer to which these components are connected via the bus 906. The information processing device 900 may include a plurality of CPUs 901, or may include a CPU 901 configured by a multiple core.

The present invention described by the above-described example embodiments as an example supplies, to the information processing device 900 illustrated in FIG. 13, a computer program being capable of achieving the following function. The function is the above-described configuration in the block configuration diagrams (FIGS. 1, 9 and 12), or the function in the flowcharts (FIGS. 8 and 11), which are referred to in description of the example embodiments. The present invention, thereafter, is achieved by reading the computer program on the CPU 901 of the hardware for interpretation and execution. The computer program supplied to the device may be stored in a readable and writable volatile memory (RAM 903) or a non-volatile storage device such as the ROM 902 or the hard disk 904.

In the above-described case, nowadays, a general procedure can be employed as a method of supplying the computer program to the hardware. The procedure is, for example, a method of installing the computer program in the device via various recording media 907 such as a CD-ROM, a method of downloading the computer program from an outside via a communication line such as the Internet, or the like. In such a case, the present invention can be regarded as being configured by codes constituting the computer program or the recording medium 907 storing the codes.

While the invention has been particularly shown and described with reference to exemplary embodiments thereof, the invention is not limited to these embodiments. It will be understood by those of ordinary skill in the art that various changes in form and details may be made therein without departing from the spirt and scope of the present invention as defined by the claims.

A part or all of the above-described example embodiments may also be described as the following supplementary notes. However, the present invention exemplarily described by the above-described example embodiments is not limited to the following.

### (Supplementary Note 1)

A communication device including:

a feature information generation means for generating, by receiving a packet transmitted from equipment that performs packet communication, information indicating a feature of the packet;

a classification mans for classifying the packet into a packet group, based on information indicating the feature, and predetermined classification criteria;

an extraction means for extracting one or more pieces of character information from the packet, based on predetermined extraction criteria; and

an identification information generation means for generating identification information by which the equipment that transmits the packet can be identified, based on character information in which a number of patterns pertaining to a structure of the character information satisfies a condition among the character information extracted from the one or more packets belonging to the same packet group.

### (Supplementary Note 2)

The communication device according to supplementary note 1, wherein

the feature information generation means generates information indicating the feature, which represents at least one of a size of the packet, a connection time of a session to which the packet belongs, a number of packets belonging to the session, a transmission interval of the packet, and a reception time of the packet.

### (Supplementary Note 3)

The communication device according to supplementary note 1 or 2, wherein

the classification criteria indicate classifying the packet into the packet group, based on a degree of similarity of information indicating the feature.

### (Supplementary Note 4)

The communication device according to any one of supplementary notes 1 to 3, wherein

the feature information generation means generates information indicating the feature, pertaining to the specific packet having a specific network attribute.

### (Supplementary Note 5)

The communication device according to any one of supplementary notes 1 to 4, wherein

the feature information generation means generates information indicating the feature pertaining to a plurality of the packets, by performing statistical calculation with respect to a feature amount of a plurality of the packets.

### (Supplementary Note 6)

The communication device according to any one of supplementary notes 1 to 5, wherein

the extraction criteria indicate extracting, as the character information, a character string indicating a header or a payload of a communication protocol of an application layer included in the packet.

### (Supplementary Note 7)

The communication device according to supplementary note 6, wherein

the extraction criteria indicate extracting the character string divided by a specific character, or the character string divided by a change in a type of a character.

### (Supplementary Note 8)

The communication device according to any one of supplementary notes 1 to 7, wherein

the identification information generation means generates the identification information, based on character information having the largest number of patterns among the character information extracted from the packet.

### (Supplementary Note 9)

The communication device according to any one of supplementary notes 1 to 8, wherein

the identification information generation means generates the identification information pertaining to each of a plurality of the packets, based on character information located at a position where an order from character information located at a leading position is same among the character information extracted from each of a plurality of the packets.

### (Supplementary Note 10)

The communication device according to any one of supplementary notes 1 to 9, wherein

the identification information generation means displays, on a display device, the packet and the identification information pertaining to the packet, in association with each other.

### (Supplementary Note 11)

The communication device according to any one of supplementary notes 1 to 10, further including

a control means for controlling transmission processing of the packet, based on the identification information pertaining to the packet received from the equipment.

### (Supplementary Note 12)

The communication device according to supplementary note 11, wherein

the control means performs, based on transmission control information indicating a content of the transmission processing for the packet transmitted from the equipment to be identified by the identification information, at least one of selecting a route along which the packet is transmitted, and discarding the packet transmitted from the equipment.

### (Supplementary Note 13)

A communication system including:

the communication device according to any one of supplementary notes 1 to 12; and the equipment.

### (Supplementary Note 14)

A communication method including:

by an information processing device,

generating, by receiving a packet transmitted from equipment that performs packet communication information indicating a feature of the packet;

classifying the packet into a packet group, based on information indicating the feature, and predetermined classification criteria;

extracting one or more pieces of character information from the packet, based on predetermined extraction criteria; and

generating identification information by which the equipment that transmits the packet can be identified, based on character information in which a number of patterns pertaining to a structure of the character information satisfies a condition among the character information extracted from the one or more packets belonging to the same packet group.

### (Supplementary Note 15)

A recording medium storing a communication program for causing a computer to execute:

feature information generation processing of generating, by receiving a packet transmitted from equipment that performs packet communication, information indicating a feature of the packet;

classification processing of classifying the packet into a packet group, based on information indicating the feature, and predetermined classification criteria;

extraction processing of extracting one or more pieces of character information from the packet, based on predetermined extraction criteria; and

identification information generation processing of generating identification information by which the equipment that transmits the packet can be identified, based on character information in which a number of patterns pertaining to a structure of the character information satisfies a condition among the character information extracted from the one or more packets belonging to the same packet group.

This application is based upon and claims the benefit of priority from Japanese patent application No. 2018-147726, filed on Aug. 6, 2018, the disclosure of which is incorporated herein in its entirety by reference.

### REFERENCE SIGNS LIST

1 Communication system
1A Communication system
10 Communication device
10A Communication device
11 Feature information generation unit
110 Feature amount
111 Packet management table
12 Classification unit
120 Classification criteria
121 Packet management table
13 Extraction unit
130 Extraction criteria
131 Packet management table
14 Identification information generation unit
140 Identification information
15 Packet communication unit
15A Packet communication unit
150A Control unit
151A Transmission control information
20 Display device
21 Server device
22 IoT gateway
23 IoT device
30 Communication device
31 Feature information generation unit
310 Information indicating feature
32 Classification unit
320 Classification criteria
33 Extraction unit
330 Extraction criteria
34 Identification information generation unit
340 Identification information
40 Equipment
400 Packet
900 Information processing device
901 CPU
902 ROM
903 RAM
904 Hard disk (storage device)
905 Communication interface
906 Bus
907 Recording medium
908 Reader/writer
909 Input/output interface

What is claimed is:

1. A communication device comprising:
a feature information generation unit configured to generate, by receiving a packet transmitted from equipment that performs packet communication, information indicating a feature of the packet;
a classification unit configured to classify the packet into a packet group, based on information indicating the feature, and predetermined classification criteria;
an extraction unit configured to extract one or more pieces of character information from the packet, based on predetermined extraction criteria; and
an identification information generation unit configured to generate identification information by which the equipment that transmits the packet can be identified, based on character information in which a number of patterns pertaining to a structure of the character information satisfies a condition among the character information extracted from the one or more packets belonging to the same packet group.

2. The communication device according to claim 1, wherein
the feature information generation unit generates information indicating the feature, which represents at least one of a size of the packet, a connection time of a session to which the packet belongs, a number of packets belonging to the session, a transmission interval of the packet, and a reception time of the packet.

3. The communication device according to claim 1 wherein
the classification criteria indicate classifying the packet into the packet group, based on a degree of similarity of information indicating the feature.

4. The communication device according to claim 1 wherein
the feature information generation unit generates information indicating the feature, pertaining to the specific packet having a specific network attribute.

5. The communication device according to claim 1 wherein
the feature information generation unit generates information indicating the feature pertaining to a plurality of the packets, by performing statistical calculation with respect to a feature amount of a plurality of the packets.

6. The communication device according to claim 1 wherein
the extraction criteria indicate extracting, as the character information, a character string indicating a header or a payload of a communication protocol of an application layer included in the packet.

7. The communication device according to claim 6, wherein
the extraction criteria indicate extracting the character string divided by a specific character, or the character string divided by a change in a type of a character.

8. The communication device according to claim 1 wherein
the identification information generation unit generates the identification information, based on character information having the largest number of patterns among the character information extracted from the packet.

9. The communication device according to claim 1 wherein
the identification information generation unit generates the identification information pertaining to each of a plurality of the packets, based on character information located at a position where an order from character information located at a leading position is same among the character information extracted from each of a plurality of the packets.

10. The communication device according to claim 1 wherein
the identification information generation unit displays, on a display device, the packet and the identification information pertaining to the packet, in association with each other.

11. The communication device according to claim 1 further comprising
a control unit configured to control transmission processing of the packet, based on the identification information pertaining to the packet received from the equipment.

12. The communication device according to claim 11, wherein
the control unit performs, based on transmission control information indicating a content of the transmission processing for the packet transmitted from the equipment to be identified by the identification information, at least one of selecting a route along which the packet is transmitted, and discarding the packet transmitted from the equipment.

13. (canceled)

14. A communication method comprising,
by an information processing device:
generating, by receiving a packet transmitted from equipment that performs packet communication, information indicating a feature of the packet;
classifying the packet into a packet group, based on information indicating the feature, and predetermined classification criteria;
extracting one or more pieces of character information from the packet, based on predetermined extraction criteria; and
generating identification information by which the equipment that transmits the packet can be identified, based on character information in which a number of patterns pertaining to a structure of the character information satisfies a condition among the character information extracted from the one or more packets belonging to the same packet group.

15. A non-transitory recording medium storing a communication program for causing a computer to execute:
feature information generation processing of generating, by receiving a packet transmitted from equipment that performs packet communication, information indicating a feature of the packet;
classification processing of classifying the packet into a packet group, based on information indicating the feature, and predetermined classification criteria;
extraction processing of extracting one or more pieces of character information from the packet, based on predetermined extraction criteria; and
identification information generation processing of generating identification information by which the equipment that transmits the packet can be identified, based on character information in which a number of patterns pertaining to a structure of the character information satisfies a condition among the character information extracted from the one or more packets belonging to the same packet group.

16. The communication device according to claim 2, wherein
the classification criteria indicate classifying the packet into the packet group, based on a degree of similarity of information indicating the feature.

17. The communication device according to claim 2, wherein
the feature information generation unit generates information indicating the feature, pertaining to the specific packet having a specific network attribute.

18. The communication device according to claim 3, wherein
the feature information generation unit generates information indicating the feature, pertaining to the specific packet having a specific network attribute.

19. The communication device according to claim 2, wherein
the feature information generation unit generates information indicating the feature pertaining to a plurality of the packets, by performing statistical calculation with respect to a feature amount of a plurality of the packets.

20. The communication device according to claim 3, wherein
the feature information generation unit generates information indicating the feature pertaining to a plurality of the packets, by performing statistical calculation with respect to a feature amount of a plurality of the packets.

21. The communication device according to claim 4, wherein
the feature information generation unit generates information indicating the feature pertaining to a plurality of the packets, by performing statistical calculation with respect to a feature amount of a plurality of the packets.
